(19) United States
(12) Patent Application Publication
(10) Pub. No.: US 2025/0262725 A1
(43) Pub. Date: Aug. 21, 2025

(54) Speed driver

(71) Applicant: Denzel Searcy, Struthers, OH (US)

(72) Inventor: Denzel Searcy, Struthers, OH (US)

(21) Appl. No.: 18/935,866

(22) Filed: Nov. 4, 2024

(51) Int. Cl. B25B 21/00; B25B 23/00

(52) U.S. Cl. CPC B25B 21/002; B25B 23/0028

(57) ABSTRACT

The idea of the speed driver is to enable users to move around small obstacles to reach screws, nuts, bolts, etc. in a way that creates less strain on the user. This makes hard to reach areas attainable while giving the user a motorized function that makes tightening and loosening less of a problem.

### BACKGROUND OF THE INVENTION

Power tools, ratchets, wrenches, screwdrivers, etc.

### BRIEF SUMMARY

The Speed Driver was designed to make hard to reach places more accessible with it's maneuverability.

### DESCRIPTION OF DRAWINGS

FIG. 1: Displays perspectives of outer square drive shaft. Includes top view, bottom view, 3D view, left side view, frontside view, as well as (at bottom) views of nearby perspectives if they were cut in half from front to back.

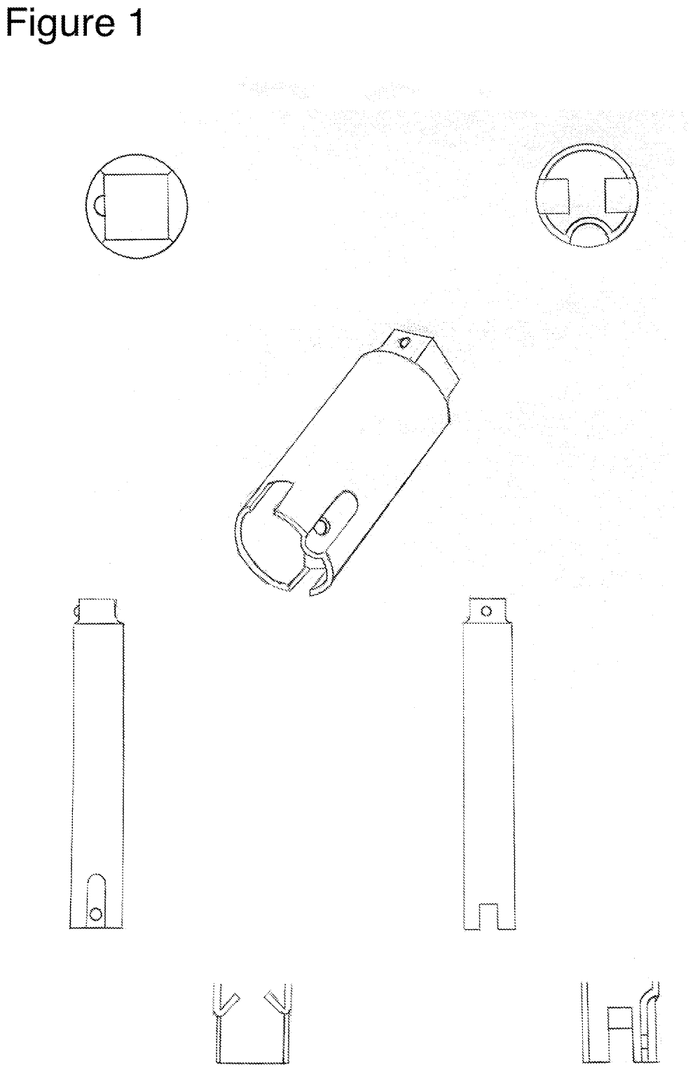

FIG. 2: Displays perspectives of inner square drive shaft. Includes top view, bottom view, 3D view, frontside view, left side view, as well as (at bottom and center) views of nearby perspectives if they were cut in half from front to back.

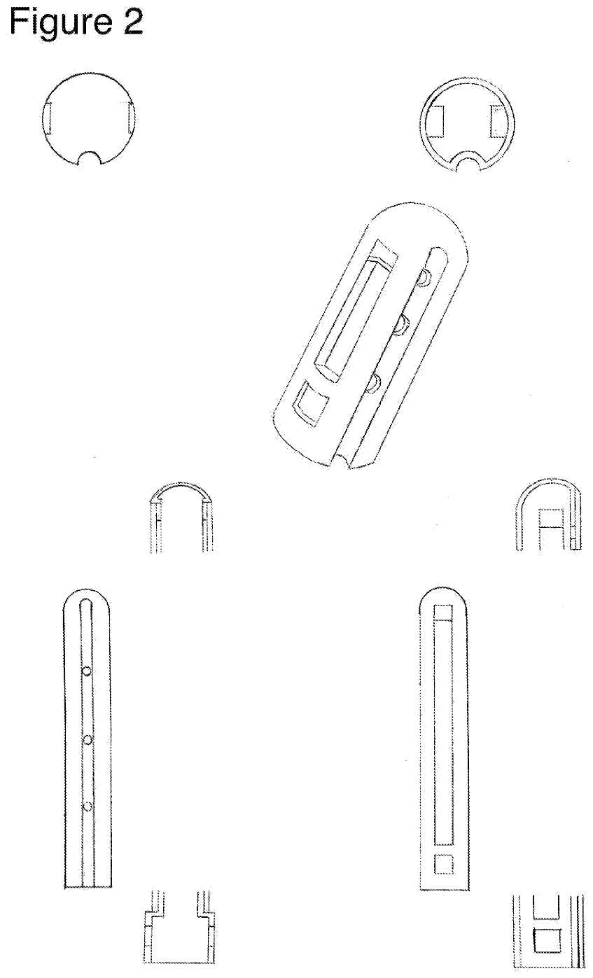

FIG. 3: Displays perspectives of extension lock. Includes top view, 3D view, left side view, and frontside view.

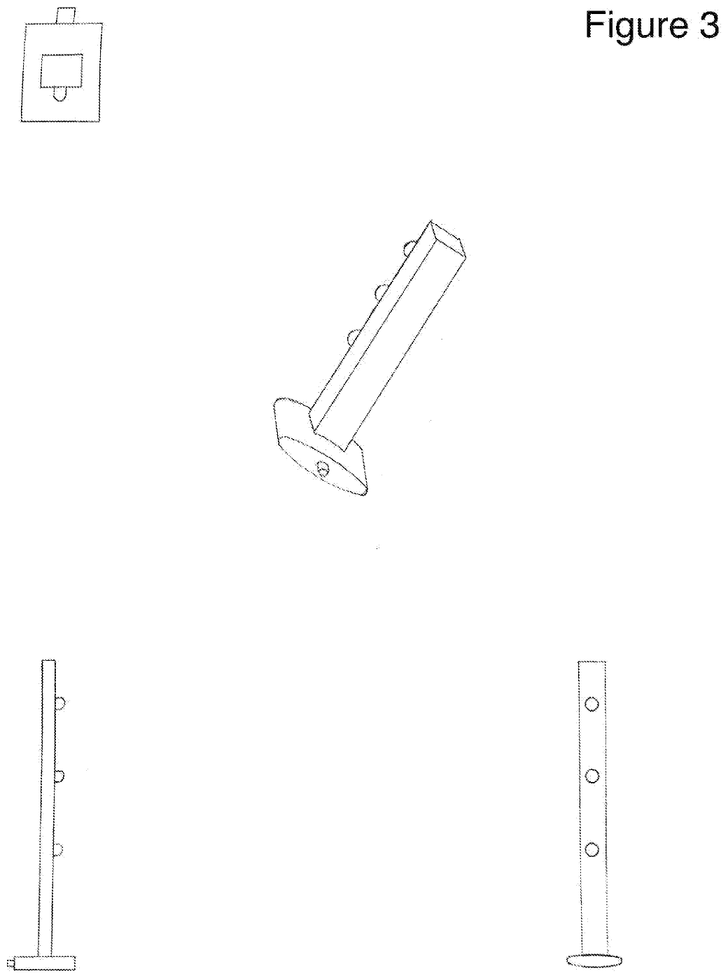

FIG. 4: Displays perspectives of half of the extension lock chamber. Includes top view, inside view, side view, bottom view, and 3D view.

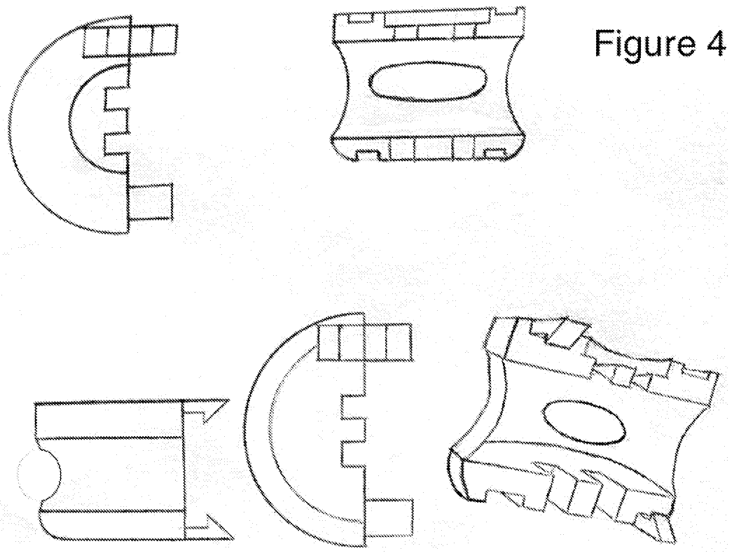

FIG. 5: 5A Displays perspectives of other half of the extension lock chamber. Includes top view, inside view, side view, bottom view, and 3D view. 5B displays a perspective of the spring used in bottom backside of the extension lock and ratchet joint push button lock.

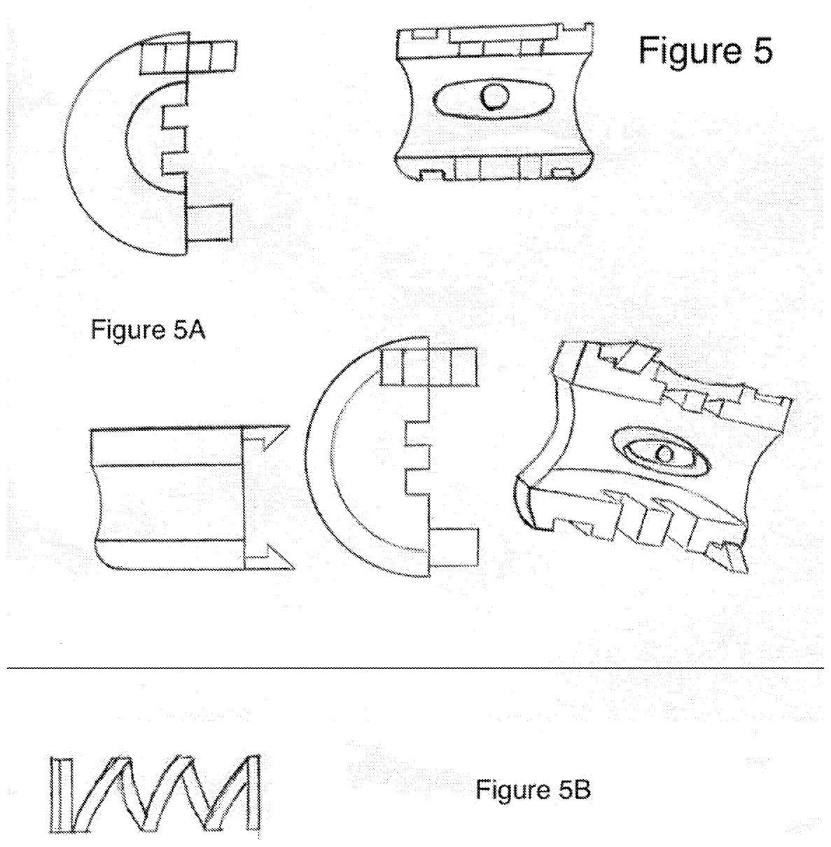

FIG. 6: 6A displays perspectives of the extension lock cover button. Includes frontside view, side view, top view, and 3D view. 6B displays top view and side view of ball bearing.

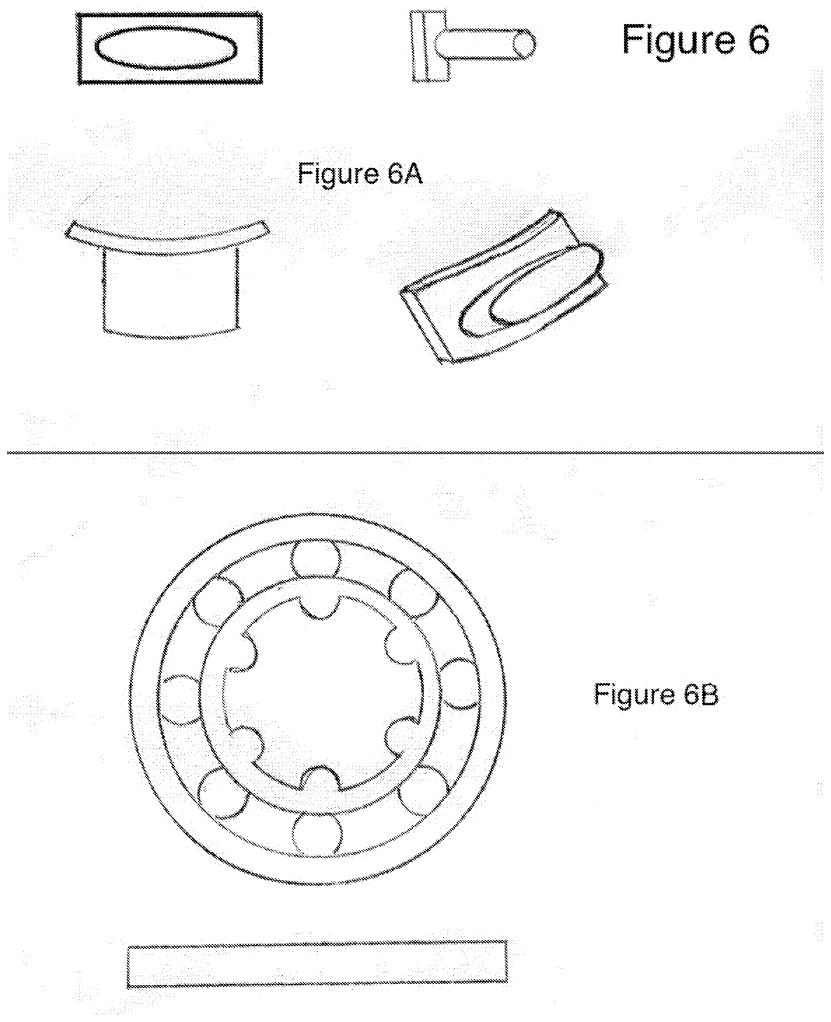

FIG. 7: Displays perspectives of top section of double universal joint. Includes frontside view, side view, top view, and 3D view.

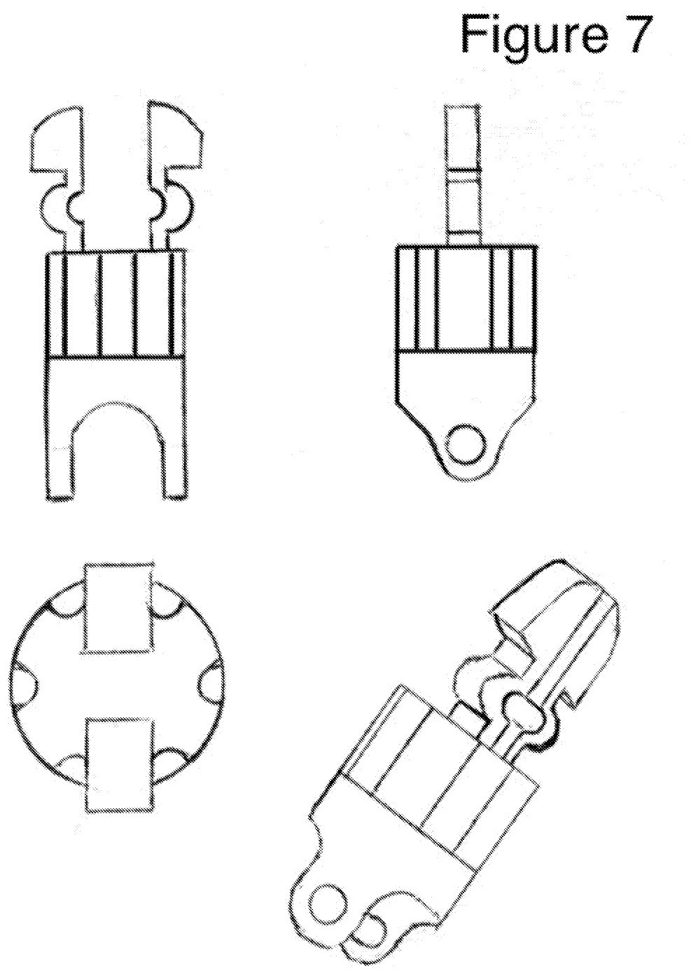

FIG. 8: Displays perspectives of half of the upper handle ratchet joint. Includes inside view, frontside view, outside view, back view, bottom view, top view, as well as (at left) inner 3D view and outer 3D view.

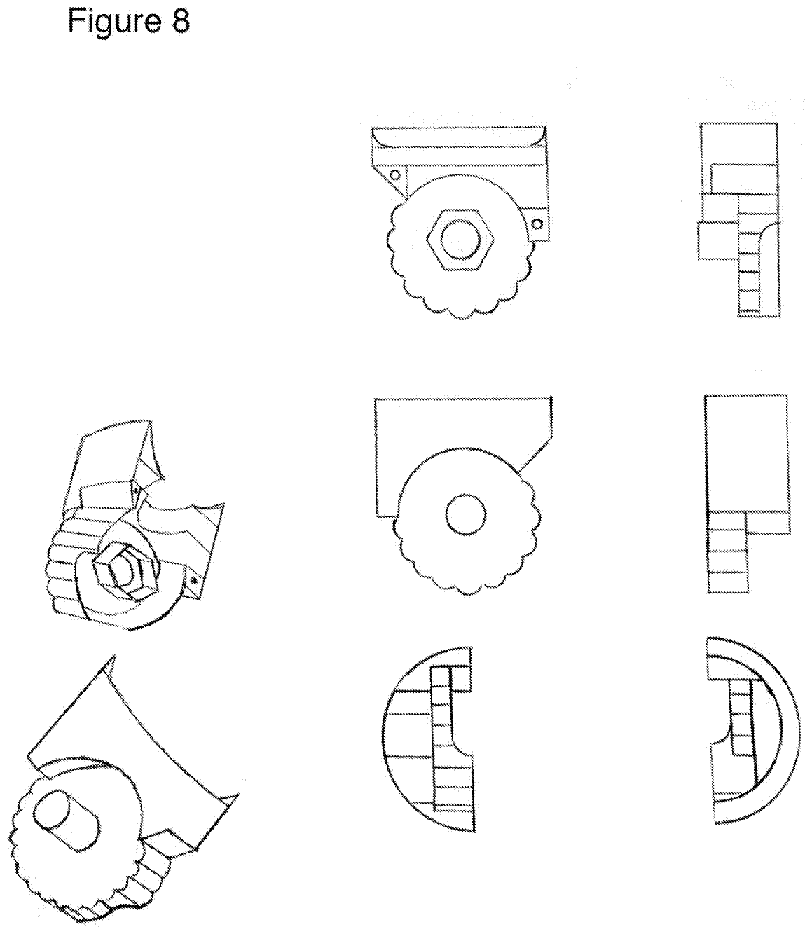

FIG. 9: Displays perspectives of the other half of the upper handle ratchet joint. Includes inside view, frontside view, outside view, back view, bottom view, top view, as well as (at right) inner 3D view and outer 3D view.

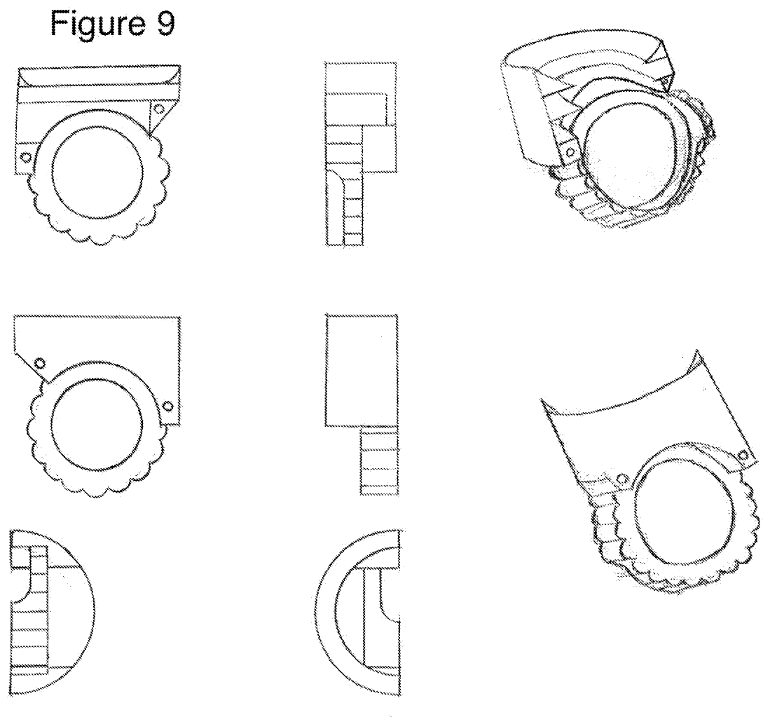

FIG. 10: 10A Displays perspectives of ratchet joint push lock button. Includes top view, side view, back view, and front view. 10B displays perspectives of lower section of double universal joint. Includes frontside view, bottom view, left side view, and top view. 10C displays a perspective of universal joint cross spider.

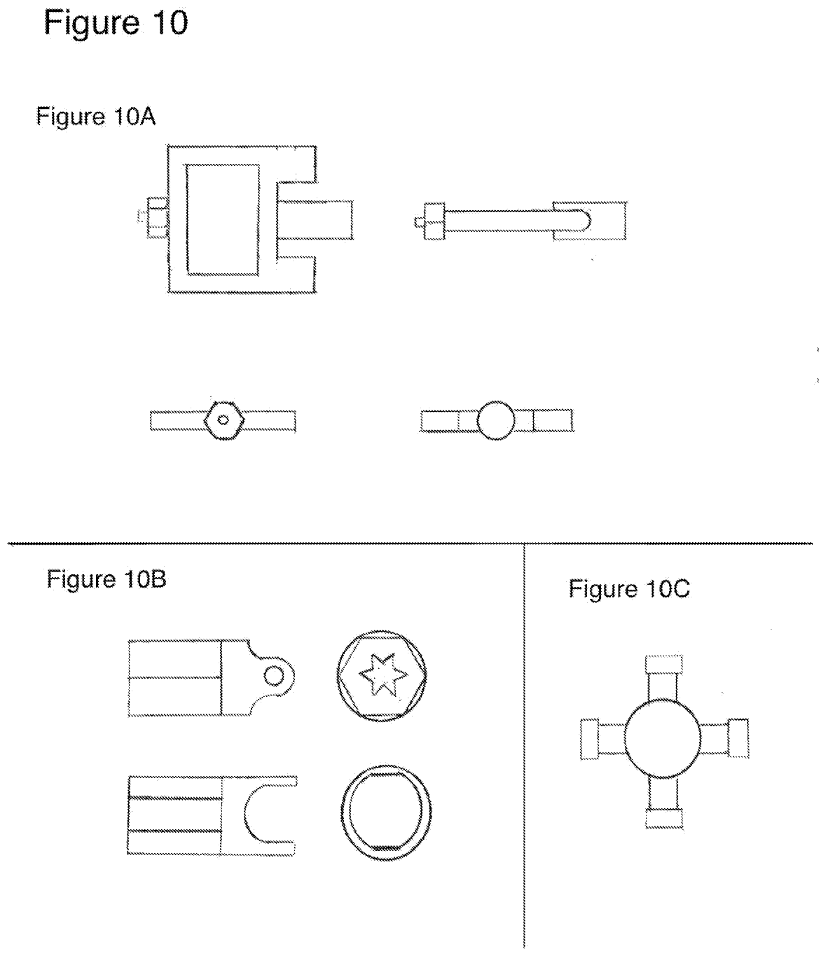

FIG. 11: 11A displays perspectives of shaft lock. Includes top view and side view. 11B displays perspectives of shaft lock spring. Includes frontside view and side view. 11C displays perspectives of midsection of double universal joint. Includes frontside view and left side view.

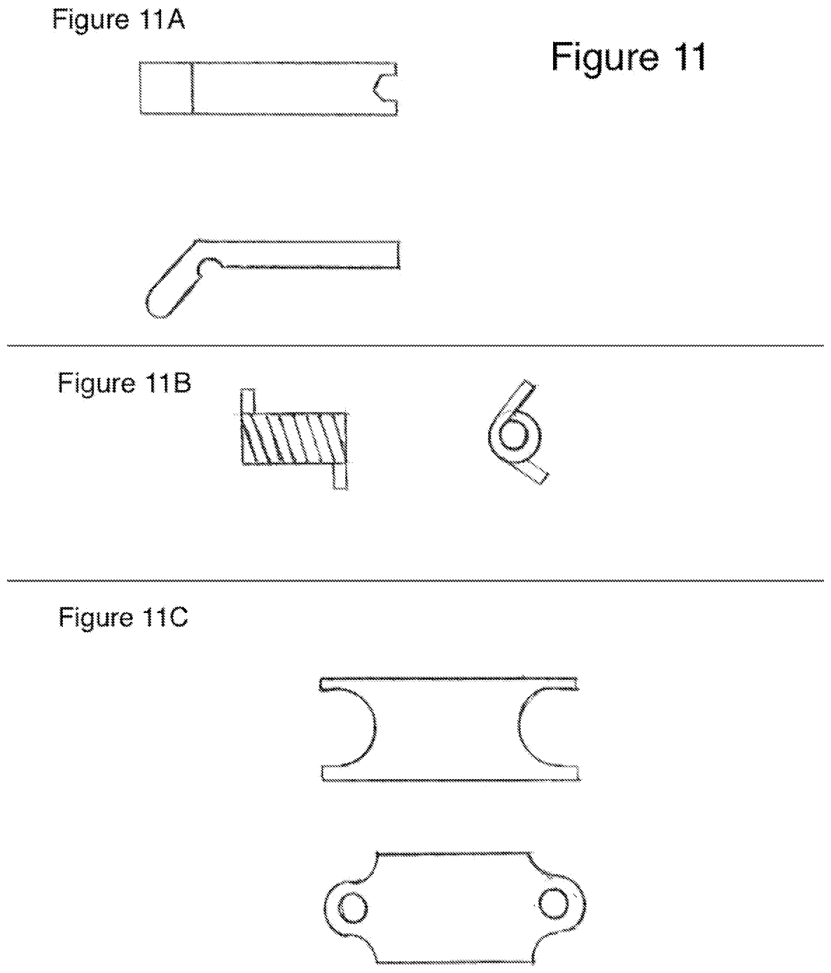

FIG. 12: 12A displays perspectives of activation switch. Includes side view, frontside view and back view. 12B displays perspectives of motor. N279939 Drill motor for DeWALT tools (used in design process). Includes side view and top view. 12C displays perspectives of reverse polarity switch. TWTADE Momentary Polarity Reverse Switch (used in design process). Includes side view and frontside view. 12D displays perspectives of rechargeable battery. Includes side view, inner view, outer view, top view, and bottom view.

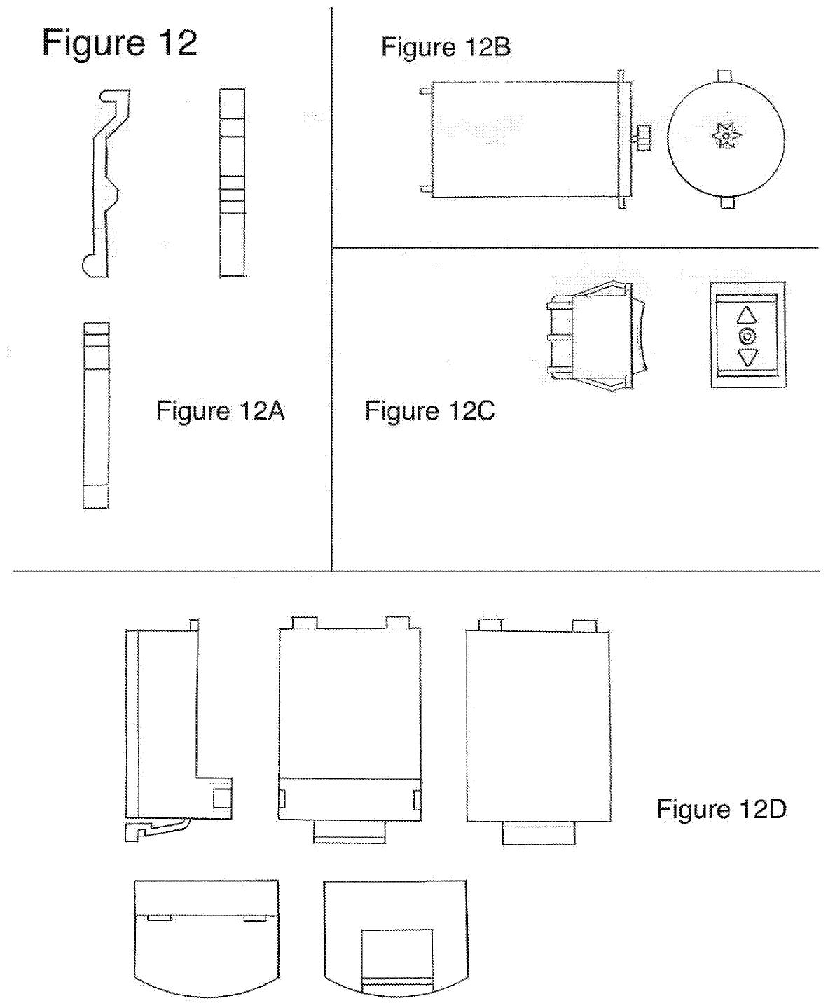

FIG. 13: Displays perspectives of half of the lower handle ratchet joint. Includes inside view, top view, bottom view, outside view, frontside view, back view, and inner 3D view.

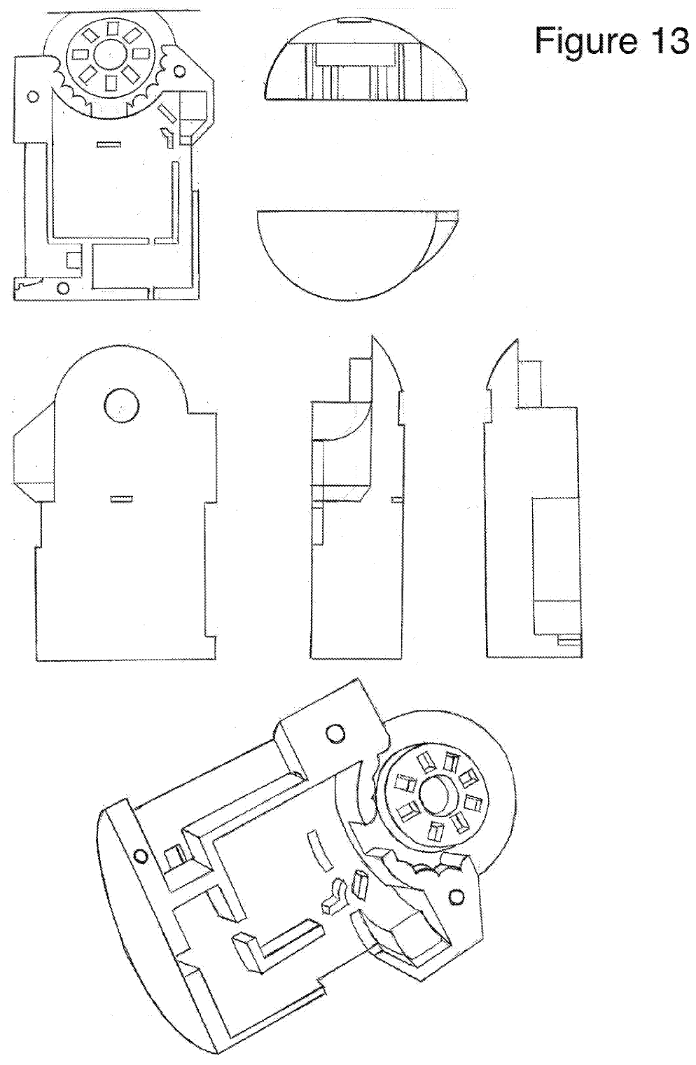

FIG. 14: Displays perspectives of the other half of the lower handle ratchet joint. Includes top view, bottom view, inside view, back view, frontside view, outside view, and inner 3D view.

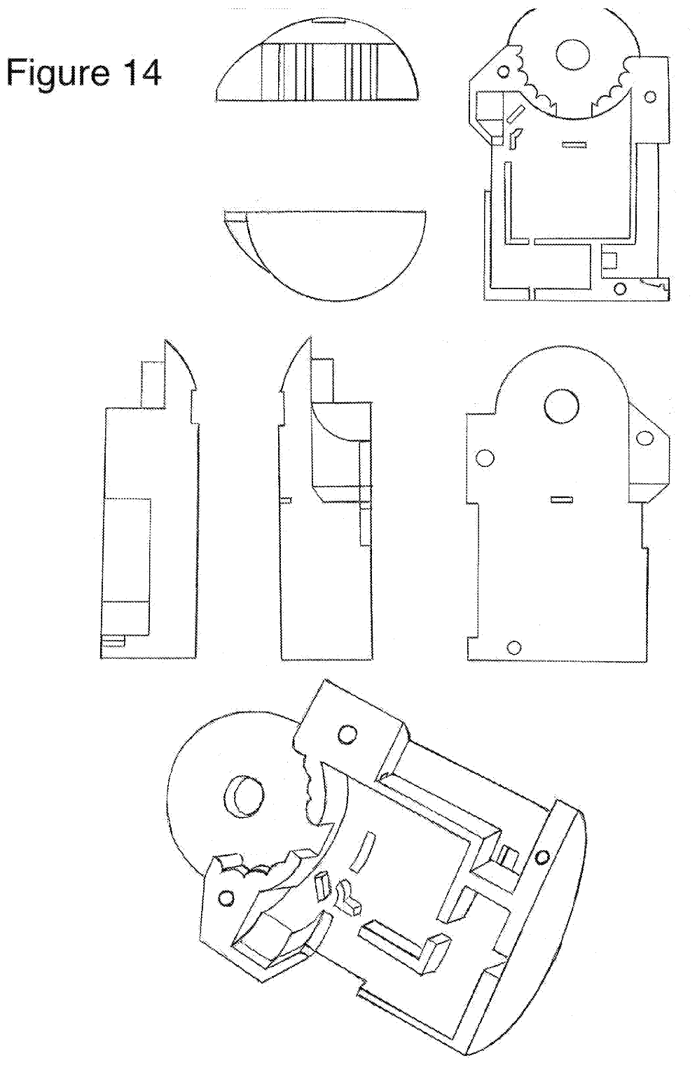

FIG. 15: Displays a visual assembly of the speed driver's different parts. 15A displays FIGS. 1, 2, 3, 6B, and 7 being assembled. 15B displays 15A along with FIGS. 4, 5A, 5B, and 6A being assembled. 15C displays 15B along with FIGS. 5B, 8, 9, 10A, 10B, 10C(×2), and 11C being assembled. 15D displays 15C along with FIGS. 11A, 11B, 12A, 12B, 12C, 13, and 14 being assembled. 15E displays 15D along with FIG. 12D already installed.

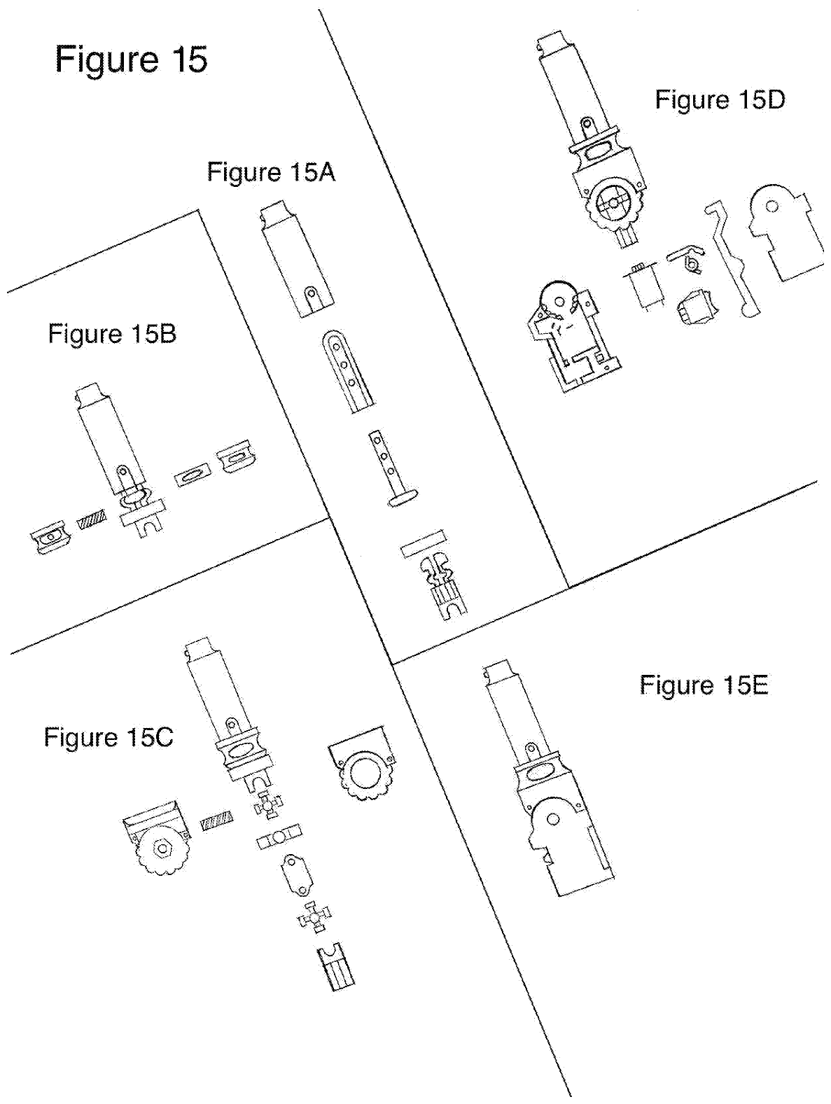

FIG. 16: Explains what the different areas of FIGS. 13 and 14 are designed for.

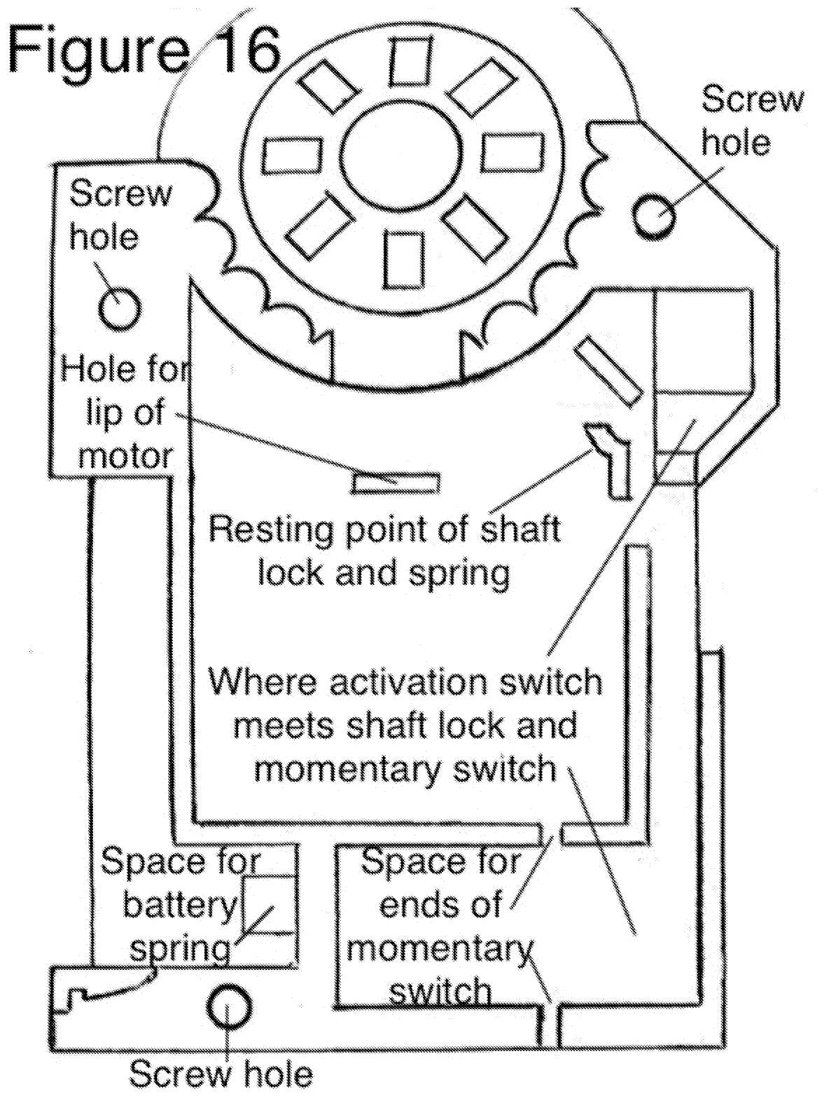

### DESCRIPTION OF INVENTION

Speed driver is a modern tool designed to make working in tight spaces easier. It has the ability to extend as well as bend 90 degrees. Thus making working on the engine of a car, a tractor, a boat, a plane, or any other engine bay much simpler. HVAC and construction sights have plenty of issues when removing bolts or screws can be a hassle due to objects in the way, but with a speed driver, obstacles can be minimized. The drive shaft of the speed driver has the ability to extend and lock in place at different lengths, making different distances in small places very reachable. The handle also has the ability to bend and lock in place within 90 degrees. That, combined with the ability to extend, gives it the ability to go places your hands might be to big for or just can't reach. All of this combined with a motor and rechargeable battery makes speed driver an optimum power tool.

1: Square drive with the ability to extend.

2: Square drive with the ability to bend 90 degrees at the handle.

3: Motorized square drive with the ability to extend.

4: Motorized square drive with the ability to bend 90 degrees at the handle.
